(19) United States
(12) Patent Application Publication
(10) Pub. No.: US 2002/0147510 A1
(43) Pub. Date: Oct. 10, 2002

(54) Process for rapidly controlling a process variable without overshoot using a time domain polynomial feedback controller.

(76) Inventor: Robert Henry Francis, Greenfield, WI (US)

Correspondence Address: Robert H. Francis, 4599 South 119th Street, Greenfield, WI, 53228-2469, US

(21) Appl. No.: 09/771,799

(22) Filed: Jan. 29, 2001

(51) Int. Cl. G05B 13/02

(52) U.S. Cl. 700/45

(57) ABSTRACT

A process for controlling a process variable to a predetermined value (setpoint) where exceeding setpoint (overshoot) is not allowed. The method this controller employs is a time domain polynomial equation in a feedback configuration. This controller also includes a method to set the controller's output to zero if the process variable moves beyond setpoint. In addition, the controller includes a method to maintain the process variable at setpoint after the process variable initially approaches setpoint when this controller is applied to process control applications. An optional method included with this controller automatically improves one of the critical tuning parameters. The result of this method is the controller acts as an On/Off controller until the process variable approaches setpoint. At that point, the controller then acts as a fast responding analog controller “tailoring” the control variable to precisely bring the process variable into setpoint without overshoot.

### CROSS-REFERENCE TO RELATED APPLICATIONS

USPTO Disclosure Document Number 469501 Dated Feb. 22, 2000.

### STATEMENT REGARDING FEDERAL SPONSERORED RESEARCH AND DEVELOPMENT

Not applicable

### BACKGROUND

1. Field of Invention

This invention relates generally to the field of industrial process control, and particularly to a method for rapidly controlling a measured variable of a process from an existing value to a very divergent desired value without an overshoot beyond the new value.

2. Description of Prior Art

Analog Controllers

Analog controllers receive a continuous analog signal input that represents a measured process value (PV) from a sensor and compares this value to the desired value setpoint (SP) to produce an error signal (ES). The controller uses this error to calculate any required correction and sends a continuous analog signal output (control variable), to a final control element (any continuously variable valve, damper, pump, fan, etc.). The final control element (FCE) then controls the process variable.

Proportional-Integral-Derivative (PID)

The original analog controller had only Proportional, or gain, control. This controller compared the process variable to the setpoint and varied the control variable as a function of a preselected multiplication value, which could be more or less than one. Because the amount of control variable change, due to deviation of the process variable from the setpoint, decreased as the process variable neared the setpoint, the process variable could continue to deviate (droop) from the setpoint indefinitely. To overcome this it was necessary to manually offset the setpoint, above or below, the desired operating value.

A function to overcome this droop was developed and was called Integral, or Reset, and was made a part of the Proportional control. This integrated the error signal as a function of the time during which the offset continued, and automatically made a pseudo offset of the setpoint to correct the droop. The amount of Integral effect was preselected by manual adjustment.

Because Proportional control and Proportional plus Integral control could not react quickly to a process undergoing a rapid deviation from setpoint, another control mode was developed and added to the analog controller. This function was named Derivative and measures the speed of process variable deviation from setpoint. The controller calculates an addition or subtraction to the control variable based on this deviation speed. The magnitude of derivative action in relation to the speed of deviation is preselected by manual adjustment.

These three modes of control may be adjusted (tuned) to work well on a continuous process, but tend to overshoot above and below setpoint during an initial start-up of a process and will oscillate for many cycles. These oscillations may be of such extreme excursions that process material is ruined or an unsafe situation may occur.

Multiple attempts have been made to control to a predetermined value (setpoint) without the measured parameter (process variable) exceeding the setpoint using the PID. The original method, and still the most common, to move the process variable to the setpoint is to configure the PID tuning parameters to slow response to process variable disturbance. See FIG. 3. A number of variations to the PID controller have been developed to solve the problem of rapidly moving the process variable, for example, setpoint suppression/reset, ramp/soak, and gap control. Setpoint suppression/reset involves setting an intermediate PID setpoint at some value less than the actual setpoint until the process variable reaches that intermediate setpoint. At that point, the controller setpoint is adjusted to the actual setpoint allowing the process variable to reach that setpoint. A ramp/soak controller moves the PID controller setpoint in small increments (ramps) over time until the controller setpoint reaches the desired setpoint. The controller then holds the process variable at the desired setpoint (soak). See FIG. 4. A gap controller utilizes a PID controller with a downstream “switch” that freezes the final control element when the process variable is within a predetermined band around the setpoint. See FIG. 5.

One of the more recent developments involves using fuzzy logic to anticipate overshoot resulting from the PID calculations; Lynch, F U.S. Pat. No. 5,909,370 (1999) (herein referred to as Lynch). In this method, a fuzzy logic algorithm is used to suppress the setpoint analogous to the setpoint suppression/reset described above. The fuzzy logic algorithm varies the magnitude of the setpoint suppression.

Currently over 90% of all analog industrial controllers have been, and remain to be, the PID controller. This controller has been shown to provide the minimum Integrated Average Error (IAE) in continuous control applications where process variable overshoot is acceptable; please see McMillan G (1994) Tuning and Control Loop Performance, Instrument Society of America, North Carolina (incorporated herein as McMillan).

The standard PID is also the primary controller used for applications where overshoot is not allowed. However, PID controllers with no-overshoot tuning parameters result in relatively slow performance. See FIG. 3. The reason for this slow performance is the no-overshoot tuned PID controller begins closing the final control element sooner than necessary. Thus, unnecessary time is required to move the process variable to the setpoint. This is because the quantity of controlled material delivered through the final control element, when it is not at its full ON position, is less than if that control element were fully ON longer.

The most significant short fall of the traditional PID when used in applications where overshoot is not allowed is that the PID does not have a feature ensuring the final control element is set OFF (as used herein, the terms OFF and ON represent succession of the control medium whether the process variable approaches the setpoint from above or below) as the process variable reaches the setpoint. The PID output often does not begin reversing direction (reducing its output after an increasing output) until after the process variable passes the controller's setpoint. Thus, the PID controller does not have systems to prevent or minimize overshoot. Often a maximum setpoint exists where a process operates optimally. However, that process cannot exceed that maximum setpoint without damage—environmental, equipment, or product. For example, a cereal tastes better when the berry is cooked at 99° C. but the berry's sugar is significantly changed if cooked at 100° C. In the more extreme case of an exothermic reaction, a reactor might explode or the relief devices actuate, if that maximum setpoint is exceeded. Without a method to ensure the final control element is set OFF if the process variable moves beyond the setpoint, the PID controller cannot ensure this damage does not occur. Thus batches can fail and equipment or environmental damage can occur when the PID controller is used for these applications. In these applications, control practitioners often set the operating setpoint below this maximum setpoint. The result is the process does not operate at the optimal point, increasing production times or decreasing production yields.

Setpoint suppression/reset, while commonly utilized in applications where overshoot is not allowed, also has slow performance as the controller first reduces the final control element's percent ON to meet the intermediate setpoint. After the intermediate setpoint is reached, the controller increases the final control element's percent ON to reach the actual setpoint. The controller reduces the percent ON when the process variable reaches the actual setpoint. Extra time is required to reach the actual setpoint than if the controller were able to move the process variable directly to the setpoint.

Ramp/soak controllers are effective in applications in which overshoot is not allowed. Typically, the final control element's percentage ON is in the middle of its percentage ON range. Because the controller's setpoint is not immediately positioned at its desired value, the final control element is not held at full ON position for the maximum time while the process variable is approaching setpoint.

While gap controllers ensure the final control element's output is set OFF when the process variable is near the setpoint, the controller acts as an on/off controller near the setpoint. Because of this action, the controller's precision is not the quality of the traditional PID or other controllers.

The fuzzy logic controller proposed by Lynch has the same shortcomings as the setpoint suppression/reset described above along with the added complexity of the fuzzy logic controller. Fuzzy logic currently is not supported by most industrial controllers and requires significant computing resources to implement.

Thus a need exists for a controller that moves the process variable to the setpoint without overshoot more rapidly than PID controllers.

Feed-Forward Control

Feed-forward control was developed to anticipate control system corrections to process disturbances before the actual process receives the disturbance. Feed-forward control attempts to measure upsets (disturbances) to the process before the upset reaches the process. The controller then calculates corrections for those upsets. An example would be a house having a method to measure whether or not the front door is open and to measure the outside temperature. If the front door opens and a significant difference exist between the outside and inside temperatures, the heating/air conditioning system would start although the inside temperature is presently at the desired value.

The most significant short fall of the feed-forward controller involves the requirement of the process under control be well understood. Often when implementing these controllers, a disturbance (an event that drives the process from the setpoint) attacks the process that was not anticipated by the engineer configuring the controller. This disturbance can make the process unstable resulting in process or equipment failure or an unsafe condition.

Model-Based Control

The latest developments in process control have been focused on advanced control algorithms including: state-space variable controllers, neural network controllers, artificial intelligence controllers, fuzzy logic controllers etc, further referred to as model-based controllers. Model-based control uses a mathematical representation of an ideally operating process to calculate correction to process upsets. The control practitioner develops the model controller based on anticipated or expected disturbances and the desired process response. Model based control uses a mathematical representation of the process to calculate corrections to process upsets. The model is typically developed using complex mathematical systems such as state-space variable matrices.

As the cost of computing systems is falling, using model-based controllers is becoming more practical. For applications where absolute control system accuracy is necessary, model-based controllers offer significant promise and advancement beyond current technologies. However, these controllers are very complex and require advanced engineering support to deploy, maintain and modify, increasing the cost of the control system. Because of the complexity of this controller, significant computing resources are required to implement these controllers. Most contemporary industrial controllers do not have these computing resources available and those that do are quite expensive. Thus, to date, these controllers have not been widely used in industrial applications.

Contemporary model-based controllers also require that the process under control be well understood and therefore suffer from the same short coming as feed-forward controllers when the control practitioner overlooks a source of disturbance. As stated above, this disturbance can make the process unstable resulting in process or equipment failure or an unsafe condition. Thus, control practitioners hesitate in implementing these controllers on new processes. In most cases, the control engineer will first install traditional feedback controllers, run the system to ensure all disturbances have been identified and then design the model-based controller. Clearly, the cost to install model-based controllers on new processes can be prohibitive.

Ingredient Addition/Filling Operations

The main analog technique employed to add ingredients or fill products is the full/trickle mode where the control element is set to a “minimum” position as the ingredients near the setpoint. The predominant technique employed to add ingredients or fill products is to start adding the product at full rate. When the added product nears the setpoint, the controller switches to a “trickle” mode in which the product flow is reduced to 10% to 25% of the full rate. When the product quantity is within acceptable error tolerances, the product flow is stopped. This trickle rate is often implemented with a second final control element.

The full/trickle mode method for ingredient addition has worked successfully for many years. It is especially successful when the motive force supplying the ingredients is constant. However, this controller's precision is reduced when that motive force varies. This is because the controller's full OFF point is dependent upon a fixed quantity of material being transferred after the final control element is fully OFF. If that force varies, the quantity of material varies. Another shortcoming of the full/trickle mode for ingredient addition is that, at the predetermined intermediate setpoint, the final control element is set to a reduced percent ON. A better method would have that final control element continuously set OFF as the ingredient quantity approaches the setpoint.

Other Prior Art References:

Traditional control theory texts, such as “Grundlagen der Regelungstechnik” Fundamentals of Control Engineering by Dorrscheidt and Latzel, Teubner-Verlag, Stuttgart, 1993 have referred to using polynomials in feedback control strategies.

While control theory texts have suggested that polynomials would make effective feedback controllers, these controllers applied polynomials in the frequency domain, not the time domain. When frequency domain polynomials of the forms:

$$\frac{1}{{s}^{2} - {a}^{2}} or \frac{s}{{s}^{2} - {a}^{2}}$$

are inverse Laplace transformed back to the time domain, the resultant equations are of the form:

$$\frac{1}{a} sin at or cos at$$

These equations result in oscillatory response from the controller, an undesirable result for process control where linear outputs are required. (Note: t is defined in these examples as the error calculation result.) If, in a more general form, the polynomial is of higher order:

$$\frac{1}{{( s - a )}^{n}} where n = 1 , 2 , 3$$

The inverse Laplace transform is:

$$\frac{1}{( n - 1 ) !} {t}^{n - 1} {e}^{at}$$

(Please see Beyer W (1981), CRC Standard Mathematical Tables, CRC Press, Inc, Boca Raton, Fla. for the inverse Laplace transforms)

This resultant controller equation includes an exponential function (e^{at}). The exponential function, by definition, does not allow the control variable to go to zero. Thus, if the process variable moves past the setpoint, the controller's output would still be greater than zero continuing to add energy or ingredients erroneously.

In order for a controller to be successfully employed in contemporary industrial process controllers (simple software based computing type, traditional electrical/electronic, pneumatic, hydraulic, etc), the controller's equations need to be time domain based. Though frequency domain type controllers have been used in linear control applications (aircraft control for example) for some time, these controllers require significant computing resources or electronics to deploy. The frequency domain controller is not economically feasible to be utilized for process control applications.

Previous attempts have been made that use an asymptotic approach to setpoint, specifically, Rae Richard, U.S. Pat. No. 4,948,950 (incorporated herein as Rae). However, Rae's method has an intermediate setpoint asymptotically approaching the final setpoint, not the process variable. The control of the process variable is left to “the microprocessor is programmed in a manner well known in the art . . . ” Like the Ramp/Soak PID controller, this approach does move the process variable to the setpoint as rapidly as if the setpoint were directly moved to its final position.

### SUMMARY

This invention is a method for rapidly controlling a process variable to a setpoint without overshoot using a time domain polynomial feedback controller. This controller first sets its output to zero if the error is negative. Otherwise the controller's output is calculated from the error signal using a time domain polynomial equation. For applications where long-term setpoint maintenance is required, the controller includes a method to automatically execute an integral correction feature. After the process variable has reached setpoint, the controller also includes a feature to automatically improve the controller's parameters. The resulting method controls process variable on its path to the desired setpoint in a quicker manner than contemporary industrial controllers.

This controller may also be utilized in product filling/ingredient addition applications resulting in lower material usage due to the more precise control.

Objects and Advantages

Accordingly, several objects and advantages of this invention are:

It provides a method to control a process variable to a setpoint without overshoot more rapidly than traditional Proportional-Integral-Derivative (PID) controller tuned for no overshoot.

It is easier to understand than the PID and other controllers.

It requires fewer resources (hardware, software, etc.) than other controllers and, because it is time domain based, may be directly implemented in contemporary industrial controllers.

It ensures the controller output is zero if the process variable moves beyond the setpoint while maintaining full control of the process variable until the process variable reaches the setpoint in a feedback controller configuration.

It reduces required energy to reach setpoint in process control applications where overshoot is not allowed.

It reduces raw material/product variability in ingredient addition/filling applications employing an analog final control element.

It may be implemented with traditional sensors and final control elements.

Further objects and advantages of this invention will become apparent from consideration of the drawings and ensuing description.

### DRAWING FIGURES

FIG. 1 is a block diagram of a control system including the polynomial controller as utilized in accordance with the method of this invention.

FIG. 2 is a flow chart of the operations that comprise the method.

FIG. 3 is a prior art plot illustrating a process variable controlled by a properly tuned PID controller and a PID controller tuned for no overshoot.

FIG. 4 is a prior art plot illustrating an ideal process variable controlled by a properly tuned Ramp-Soak PID controller.

FIG. 5 is a prior art plot illustrating a process variable controlled by a Gap PID controller.

FIG. 6 is a plot illustrating a process variable controlled by a PID controller tuned for no overshoot and a process variable controlled by a time domain feedback polynomial controller with typical parameters.

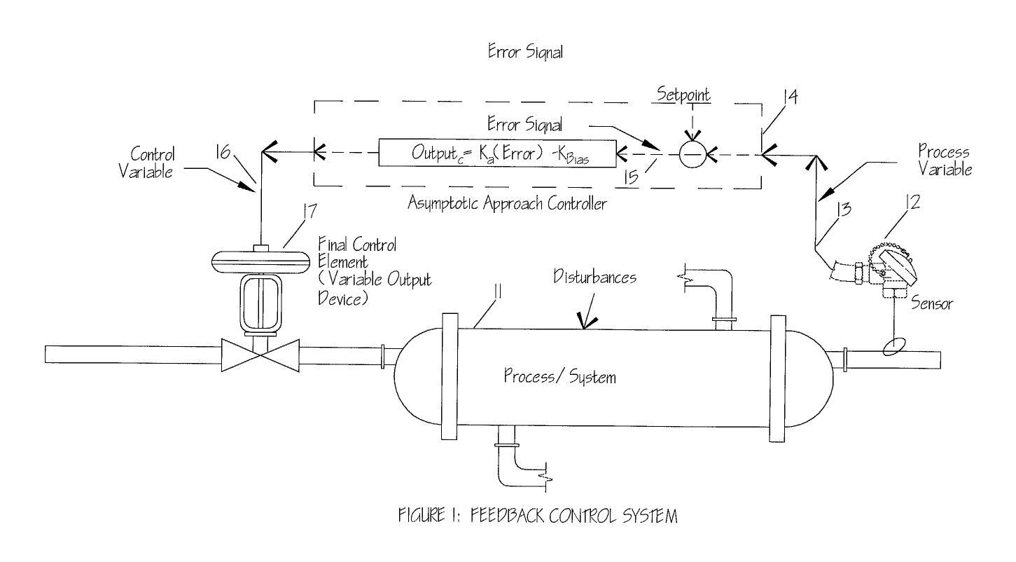

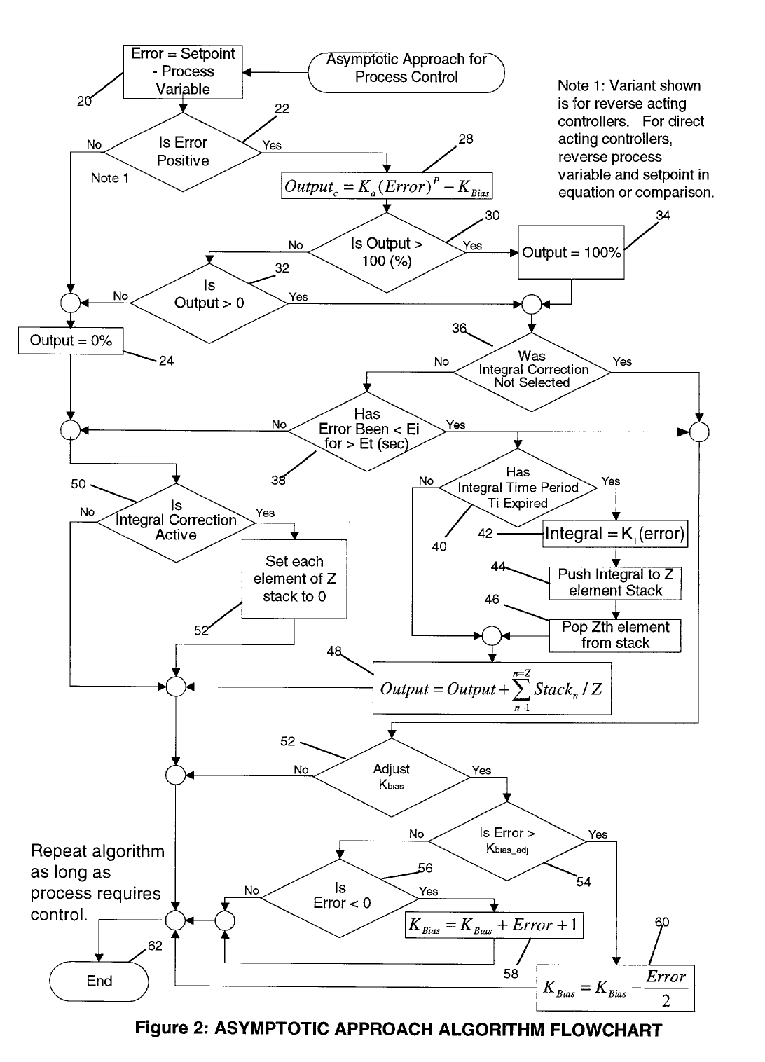

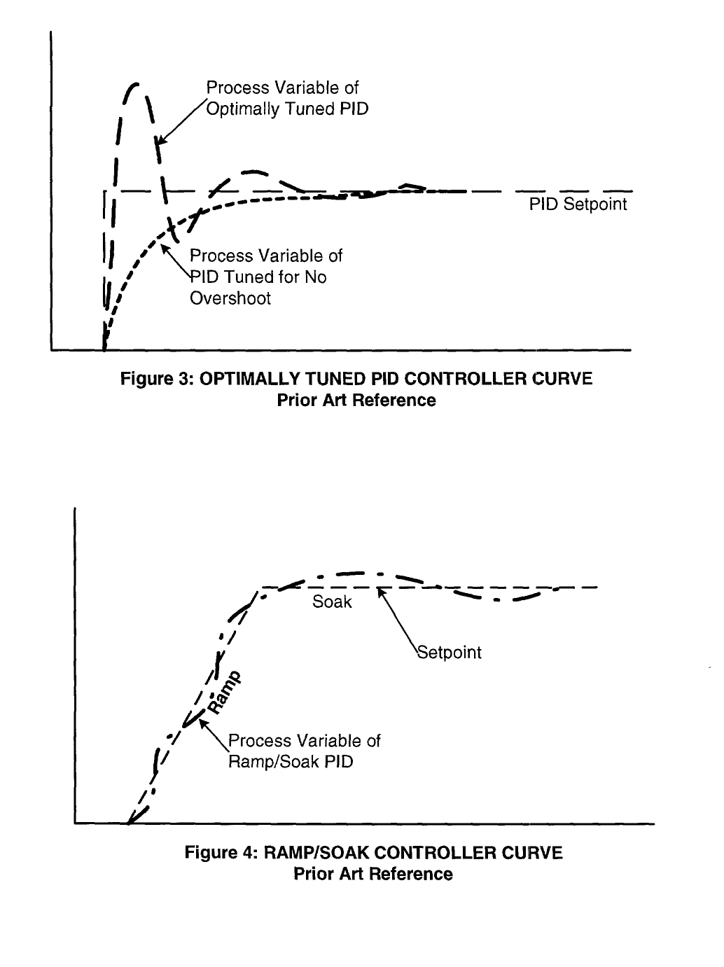

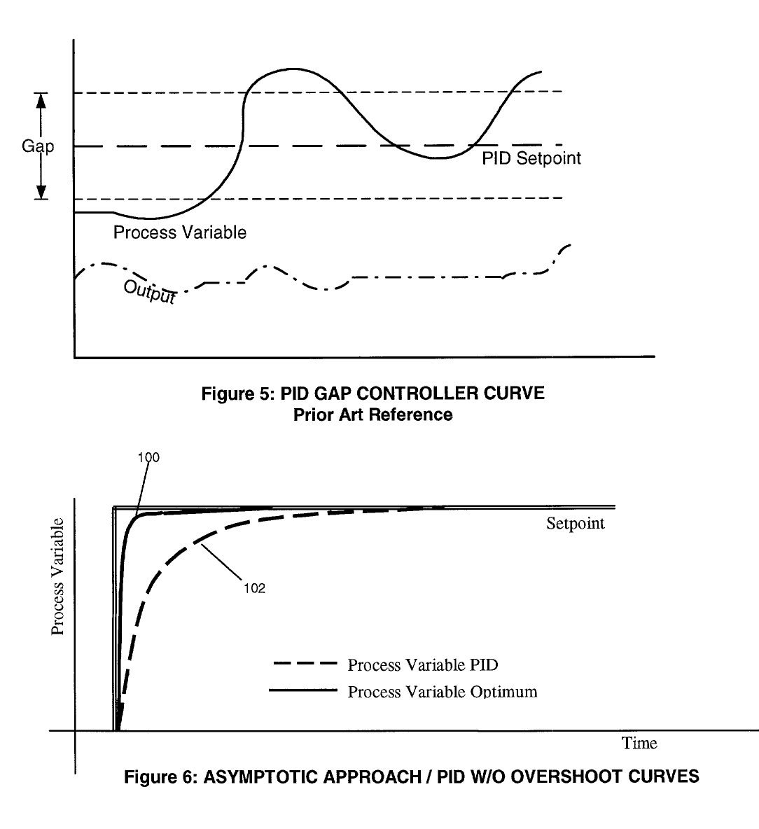

### DESCRIPTION—FIGS. 1 AND 2

FIG. 1 is a block diagram of a standard process/system in need of control with a feedback control system. This system has: a general process or system 11, a sensor 12 to measure a process variable 13, an analog controller 14 and a final control element 17 as its general equipment.

The process variable is a parameter that is an indication of the chemical or physical state of that system. The controller is a hardware or software based device that is used to calculate corrections to differences between a setpoint and the measurement. The first operation within the controller is a means to calculate an error signal 15 that is the difference between a setpoint and the process variable. The controller operates upon the error signal 15 to calculate a control variable 16. The control variable is the position at which the final control element needs to operate in order for the process variable to reach and maintain the setpoint. The final control element may be any variable output device. While a valve is shown in FIG. 1, any variable output device may be used.

In the preferred embodiment of the controller of this invention is as illustrated in FIG. 2: Asymptotic Approach Algorithm Flowchart. The controller has a means 20 to calculate an error signal. The controller compares the error signal 15 to zero. If the error signal 15 is negative, the controller's output 16 is set to zero. If the error signal 15 is positive, the output 16 is calculated using a time-domain polynomial Equation 28 as follows:

Output_{c}=Kₐ(Error)^{p}−K^{Bias}

Where:

Kₐ is Term 1 Gain (unitless)

^{p} is Polynomial Term (unitless)

K_{Bias} is Output Bias (unitless)

Returning to FIG. 2, the control variable 16 is checked to ensure it is less than 100% 30. If it is not, the control variable 16 is set to 100% 34. The control variable is checked to ensure it is positive 32 if it is less than 100%. If negative, the control variable 16 is set to zero 24.

The controller checks to determine if Integral Correction 36 is to be executed. If Integral Correction 36 is selected, the controller checks to determine if the process variable 13 is within a user selected error band Eᵢ for a user selected time Eₜ 38. If Integral Correction is activated 38, a means to integrate and average the error signal 15 over time is used. The result of the averaged-integrated error signal is added, positively or negatively, to the polynomial equation output as follows:

Output_{c}=Kₐ(Error)^{p}−K_{Bias}+Integrated_{—}Error

While not the only method, one method to integrate the error is shown in FIG. 2. At predefined intervals 40, the current error signal 15, is “Pushed” or loaded into the first position of a Z element software stack 44. At this same time the Z^{th} element is “Popped” or unloaded from the stack and discarded 44. The stack is summed and averaged as described above 48.

If the error signal 15 is negative while Integral Correction 38 is active, averaged integrated error output is set to zero 52. Thus the integration operation will start from zero the next time Integral Correction 38 is executed.

The next function of the controller is a user selectable method to improve the K_{Bias} term. If the user has selected Automatic Bias Improvement 52, the error signal 15 is checked against a user selected K_{bias}_{_{—}}_{adj} 54 at the time point 38 that Integral Correction is initiated if used. If the error signal is greater than K_{bias}_{_{—}}_{adj} 54 and positive, the new K_{bias}_{_{—}}_{adj} is calculated as follows: 58:

K_{Bias}=K_{Bias}−(Error/2).

If the error signal is greater than K_{bias}_{_{—}}_{adj} 54 and negative, the new K_{bias}_{_{—}}_{adj} is calculated as follows: 58:

K_{Bias}=K_{Bias}+ABS(Error)+1 [where ABS is absolute value function].

If the process remains in need of control, the algorithm is repeated from the top of the flowchart.

Pseudocode For Asymptotic Approach Algorithm

The following is a pseudocode description of this invention:

If Process Variable > Setpoint (for reverse acting process) {If Process Variable < Setpoint
(for direct acting processes)} [IF-THEN-ELSE Structure 1]
Then:

Calculate the error signal:

Error = Measurement − Setpoint [for reverse acting processes]
Error = Setpoint − Measurement [for direct acting processes.]

| Calculate Control Variable: | | |
|---|---|---|
| Output_{c} = Kₐ(Error)^{p} − K_{Bias} | | |
| Where: | | |
| Kₐ | is | Term 1 Gain (unitless) |
| ^{p} | is | Polynomial Term (unitless) |
| K_{Bias} | is | Output Bias (unitless) |
| Output_{c} | is | Equation Output |

If Output_{c} > 100% [IF-THEN-ELSE Structure 2]
Then

Output = 100% [maximizing controller input to process]

Else [IF-THEN-ELSE Structure 2]

If Output_{c} < 0% [IF-THEN-ELSE Structure 3]
Then

Set Output to 0% [stopping controller input to process]

Else [IF-THEN-ELSE Structure 3]
Output = Output_{c}
If Error < Eᵢ for Eₜ [IF-THEN-ELSE Structure 4]
[Where: Eᵢ = User Selected Error at which point polynomial calculation stops
execution and integral correction begins execution. If user does not desire
Integral Correction, this value is set to zero.
Eₜ = User Selected Time at which point polynomial calculation stops execution
and integral correction begins execution.]

Then:

If Time < Tᵢ [IF-THEN-ELSE Structure 5]

[Where: Tᵢ = User Selected Integral Time Period]

Then

Integral = Kᵢ

[Where: Tᵢ = User Selected Integral Time Period

Push Integral to Z element Integral Stack
Pop Z^{th} element from Integral Stack]

Else [IF-THEN-ELSE Structure 5]
EndIf [IF-THEN-ELSE Structure 5]

$$Output = {Output}_{c} + {\sum }_{Z = 1}^{Z = n} {Stack}_{n} / Z$$

If User Selected Automatic Parameter Improvement [IF-THEN-ELSE Structure 6]

Then

If Error > K_{bias}_{—adj} [IF-THEN-ELSE Structure 7]

Then

K_{Bias} = K_{Bias} − (Error/2)

Else [IF-THEN-ELSE Structure 7]

If Error < 0 [IF-THEN-ELSE Structure 8]
Then

K_{Bias} = K_{Bias} + ABS(Error) + 1

[where ABS is absolute value function]

Else [IF-THEN-ELSE Structure 8]
EndIf [IF-THEN-ELSE Structure 8]

Else [IF-THEN-ELSE Structure 7]
EndIf [IF-THEN-ELSE Structure 7]

EndIf [IF-THEN-ELSE Structure 6]

Else [IF-THEN-ELSE Structure 4]
EndIf [IF-THEN-ELSE Structure 4]

EndIf [IF-THEN-ELSE Structure 3]

EndIf [IF-THEN-ELSE Structure 2]

Else: [IF-THEN-ELSE Structure 1]

Set Output to 0% [stopping controller input to process]
If Integral Correction is active [IF-THEN-ELSE Structure 9]

Set each element of PI stack to Zero

Else [IF-THEN-ELSE Structure 9]
EndIf [IF-THEN-ELSE Structure 9]

EndIf [IF-THEN-ELSE Structure 1]

Repeat algorithm while process is in operation

Additional Embodiment

A means is provided for inclusion of a first order Kb term in the controller Equation 28:

Output_{c}=Kₐ(Error)^{P}+K_{b}−K_{Bias}.

Where:

Kₐ is Term 1 Gain (unitless)

^{p} is Polynomial Term (unitless)

K_{b} is Term 2 Gain (unitless)

K_{Bias} is Output Bias (unitless)

It is understood that a K_{b} term will be set to zero in almost all applications. This is because a similar curve may be obtained from this equation with a K_{b} greater than zero as the curve generated with Equation 28 with a ^{P} term between 1.0 and 2.0. However, the K_{b} is included here for completeness of the controller and to allow the user another method to achieve a specific process variable curve.

Operation - FIGS. 1 And 2

The controller first calculates the error signal 15. The error signal 15 is then checked to verify the error signal 15 is positive. If not, the control variable 16 is set to zero along with the Integral Correction 38, if used.

If the error signal 15 is positive, the controller uses the error signal 15 to calculate the final control element's 17 position. The error signal 15 is raised to the power^{P}. Thus, the process variable approaches the setpoint asymptotically or follows a parabolic curve when approaching the setpoint. See FIG. 6 100. If process and instrument systems were ideal, the energy or ingredients would not continue to be supplied to the system at the point the process variable 13 equals the setpoint as the final control element is set to zero at this point. However, systems take time to react. Final control elements need time to position, processes need time to react or operate, and sensors need time to measure. The summation of this time quantity is known as dead-time. To overcome the problem of dead-time in this invention, a user configured K_{Bias} is subtracted from the intermediate control variable. This ensures the final control element 17 is set to zero while the dead-time expires and the process variable 13 does not exceed the setpoint.

If the user selectable Integral Correction 36 is selected, it acts to overcome differences between the setpoint and the process variable 13. The user would select Integral Correction 36 if long-term setpoint maintenance were desired. An example application would include batch reactor temperature adjustment application where the reactor's ingredient temperature moves toward ambient temperature over time. Integral Correction 36 would be bypassed for applications where the system is reset immediately after the control variable is set to zero. Example applications where Integral Correction 36 would not be used would be ingredient addition or product filling type applications.

After the controller moves the process variable 13 close to the setpoint, the system may switch to Integral Correction if configured to do so by the user. If selected, Integral Correction 38 integrates the error of recent time and adds that integrated-averaged resultant to the control variable. Thus any difference between the process variable and the setpoint will be eliminated. To minimize process variable 13 overshoot after the controller switches to Integral Correction 38, the averaged-integrated error resultant is set to zero 52 along with any integration “history” if the process variable 13 moves beyond the setpoint while Integral Correction 38 is active. Thus, the integration operation will start from zero the next time Integral Correction 38 is executed.

To improve the K_{bias} term, the controller includes a user selectable option to automatically adjust that term. At the same time point that Integral Correction 38 would be executed, Automatic Bias Improvement is executed, if the user has so selected. The error signal 15 is first checked to ensure it is positive. If positive, the current error is divided by two and that becomes the new K_{bias}. If negative, one is added to the current K_{bias}.

The algorithm is repeated as long as the process/system 11 is active.

Conclusion, Ramifications, and Scope

Thus, as seen in FIG. 6, this control method moves the process variable 13 to the setpoint more rapidly than does the PID controller 102 tuned for no overshoot. Because of this, applications in which overshoot is not allowed will use less energy or ingredients to reach setpoint when this controller is used. In practice, notable reductions in process execution times, and energy used, have been realized.

If the process variable moves beyond the setpoint, this controller ensures the output is set OFF due to FIG. 2, 22 along with the K_{Bias} task. Thus, overshoot is prevented while having the process variable rapidly move to the setpoint when this controller is properly applied.

Also, this controller utilizes a relatively simple polynomial equation to derive its control variable and does not require significant hardware or computing resources to deploy. Another advantage of the polynomial equation based controller is it is easier to understand than calculus based functions of the controller types.

As the controller does not require significant resources to deploy, it may easily be implemented using contemporary industrial controllers, sensors, and final control elements.

As the method that the process variable approaches the setpoint is a smooth continuously decreasing asymptote, this controller offers an improved method to add ingredients or fill products over the full/trickle method. This is because the full/trickle method has 3 discrete step reductions in ingredient flow: full, trickle, off. Thus, product variability is reduced as the control precision is increased.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than examples given.

### SEQUENCE LISTING

Not Applicable.

I claim:

1 A process for rapidly controlling a process variable to a setpoint without overshoot using a time domain polynomial feedback controller comprising the steps of:
a. A means for calculating an error signal by comparing a process variable to a setpoint;
b. A means for setting said controller's output to zero if said error signal is negative;
c. A means for calculating said analog controller's output using a user tuned time domain polynomial equation in a feedback configuration;
d. A means for automatically converting to an integral correction for said setpoint maintenance based on user defined criteria; and
e. A user selectable means for improving a bias tuning parameter automatically based on user defined criteria.
Whereby said controller moves said process variable to said setpoint more rapidly in applications where overshoot is not allowed requiring less energy or materials necessary to achieve said setpoint.

2 A process for rapidly controlling a process variable to a setpoint without overshoot using a time domain polynomial feedback controller as claimed in claim Al wherein said controller is used in ingredient addition or filling applications employs steps a., b., c., and e.
Whereby said controller improves process variability when used for product filling or ingredient addition applications requiring less materials necessary to achieve said setpoint.
